(19) United States
(12) Patent Application Publication
(10) Pub. No.: US 2026/0028085 A1
(43) Pub. Date: Jan. 29, 2026

(54) ELECTRIC MOTORBIKE AND COMPONENT ASSEMBLIES THEREOF

(71) Applicant: Ryvid, Inc., Hawaiian Gardens, CA (US)

(72) Inventors: Dong L. Tran, Huntington Beach, CA (US); Ricardo Padilla, Ontario, CA (US); Tyson L. Cobb, Pensacola, FL (US)

(21) Appl. No.: 18/996,145

(22) PCT Filed: Jul. 19, 2023
(86) PCT No.: PCT/US2023/028185

§ 371 Date: Jan. 17, 2025

Related U.S. Application Data
(60) Provisional application No. 63/390,631, filed on Jul. 19, 2022.

(51) Int. Cl. B62K 11/10; B62J 1/02; B62J 6/026; B62K 19/08; B62K 19/26

(52) U.S. Cl. CPC B62K 11/10; B62J 1/02; B62J 6/026; B62K 19/08; B62K 19/26; B62K 2204/00

(57) ABSTRACT

An electric motorbike has a metal frame made of stainless steel that is folded and mechanically fastened together. The electric motorbike includes an electric motor assembly that is comprised of interconnected parts including an electric motor, swing arms, and a belt assembly which connects the electric motor and swing arms to a rear wheel assembly of the bike. A removable battery housing is configured to store a battery module within the battery housing. The battery housing and the electric motor are situated on the lower portion of the electric motorbike which lowers the center of gravity of the bike. A seat adjustment actuation system enables the adjustment of the seat via a push button system while a rider is seated on the bike.

### PRIORITY

This application is a national phase of PCT/US2023/028185, filed Jul. 19, 2023, which application claims benefit of priority to U.S. Provisional Application No. 63/390,631, filed Jul. 19, 2022. The contents of each of the above-identified applications are hereby incorporated by reference in their entirety.

### TECHNICAL FIELD

Examples described herein relate to electric vehicles, and more specifically, to electric motorbikes and component assemblies thereof.

### BACKGROUND

The use of electric vehicles (EVs) has increased dramatically with the ever-increasing rise in the cost of oil and gas. Prior manufacturing techniques of electric vehicles involve complicated methods that are cost prohibitive. Today, people are more concerned than ever about their impact on the environment (e.g., carbon footprint). Currently available solutions do not provide a modular electric vehicle that may be produced on a large scale.

### BRIEF SUMMARY

The present embodiments may relate to, inter alia, an accessible electric motorcycle with a quick removable battery pack. The disclosed was designed for urban commutes and short jaunts onto the freeway with a top speed of around 80 mph. The objective of the invention is to make electric 2-wheel commuting accessible at a lower price point to the masses. The electric motorbike may be modular and may have a metal frame formed by foldable metal that is mechanically fastened. The metal frame may comprise of stainless-steel materials that is folded during a manufacturing process to form the frame of the motorbike. The stainless-steel material may have a thickness of 2.5 mm. Reinforced panels may be provided and mechanically fastened together.

In one aspect, an electric motorbike having a metal frame is provided. The electric motorbike may include an electric motor assembly, a belt assembly, swing arm assembly, and a rear wheel assembly. In some embodiments, the electric motor assembly includes an electric motor that may be powered by a battery module. In at least one embodiment, the electric motor may include cooling fins which run along the bottom side of the electric motor to prevent the motor from overheating. The belt assembly includes a belt that is attached to the electric motor and the rear wheel assembly to control movement of the electric motorbike. The belt may be tensioned with no slack so that the entire unit rotates together.

In another aspect, an electric motorbike having a metal frame is provided which includes a removable battery module and battery housing. The battery housing may be comprised of foldable metal materials (e.g., stainless steel) that are reinforced to protect a battery module within the housing. Additionally, or alternatively, the battery housing may be reinforced with the use of one or more skid plates. In some embodiments, the battery housing may include 2-4 wheels for easy transport of the housing when removed from the electric motorbike. The battery housing and battery module may include an integrated charging system.

In yet another aspect, an electric motorbike having a metal frame is provided which includes a computing system and display controller. In some embodiments, a plurality of sensors may be placed within different components of the electric motorbike to monitor and maintain operation of the motorbike. For example, computing system may include a display unit that provides a user, or rider, of the motorbike real-time feedback of the operation status of the electric motorbike. For example, operation status of the motorbike may include efficiency (e.g., electric motor operation/battery usage), electric motor feedback (e.g., status, temperature), battery feedback (e.g., charge remaining, charge cycles remaining, temperature), or the like. The computing system may include additional functionality, such as a motor controller, a battery controller, and a passive entry/security system for the electric motorbike.

In another aspect, an electric motorbike having a metal frame is provided which includes a seat adjustment and actuation system. In some embodiments, a button or switch may be provided, such as on the handlebars of the motorbike, to adjust the height of the motorbike's seat. A rider of the electric motorbike may be seated on the motorbike during height adjustment. When the button is pressed, an electronically actuated seat height adjuster smoothly lowers or raises the seat between 30 to 34 inches above the ground.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown.

FIG. 1 illustrates an electric motorbike 100, according to one or more embodiments.

FIG. 2A illustrates a frame assembly process for manufacturing a frame or frame component for a component assembly of a vehicle, according to one or more embodiments.

FIG. 2B illustrates construction of an example frame segment, in accordance with a method such as described with FIG. 2A.

FIG. 2C illustrates a frontal view of a front segment for a frame assembly of an electric motorcycle.

FIG. 2D illustrates a headtube component, according to one or more embodiments.

FIG. 3A through FIG. 3C illustrates electric motor drive assembly 120, according to one or more embodiments.

FIG. 4A through FIG. 4D illustrate a battery assembly and battery frame, according to one or more embodiments.

FIG. 5A through FIG. 5C illustrate an example motorbike having an adjustable seat assembly, according to one or more embodiments.

FIG. 6A and FIG. 6B illustrate a lighting assembly, according to one or more embodiments.

FIG. 7 illustrates a cable feature for use with handlebar assembly, according to one or more embodiments.

FIG. 8A through FIG. 8I illustrate alternative views of an electric motorbike, according to one or more embodiments.

FIG. 9 illustrates a removable battery assembly, according to one or more embodiments.

FIG. 10 illustrates another headtube component, according to one or more embodiments.

FIGS. 11A-11G illustrate alternative views of an electric motorbike, according to one or more embodiments.

The Figures depict preferred embodiments for purposes of illustration only. One skilled in the art will readily recognize from the following discussion that alternative embodiments of the systems and methods illustrated herein may be employed without departing from the principles of the embodiments described herein.

### DETAILED DESCRIPTION

Examples provide for an electric motor frame for a motorbike. The electric motor frame includes a main segment to house an electric motor, and an arm segment extending rearward from the main segment to house a belt drive system.

Still further, in some examples, an electric motorbike is provided that includes an integrated frame that encases a rear drive unit, where the rear drive unit includes an electric motor operatively engaged with an electrical motor.

In some examples, the arm segment is structured to form a swing arm for the electric motor frame when assembled on an electric motorbike.

In some embodiments, a electronic motorbike is provided. The electric motorbike may include a metal frame that may be mechanically fastened together. The metal frame may comprise of stainless-steel material that is folded during manufacture to form the frame for the motorbike. The stainless-steel material may have a thickness of 2.5 mm. Panels of the metal frame may be mechanically fastened together to reinforce portions of the frame. As described herein, the motorbike may include, inter alia, an electric motor, a removable battery and battery compartment, a seat adjustment actuation system, a lighting assembly, and a computing system.

The disclosed electric motorbike may include a plurality of computer devices that may or may not be communicatively coupled to each other for operation of the motorbike. Example computer devices may include but are not limited to a computing device with a display and display controller, a motor controller, a battery controller, and a passive entry security system.

In some embodiments of the disclosed technology, a computer display may be provided with a user interface. The user interface may provide user selectable components that provide information to a rider of the electric motorbike. Information may be obtained from one or more sensors installed on or within components of the motorbike. Sensors may include but are not limited to battery sensors, motor sensors, or the like. For example, temperature sensors may be used to monitor the temperature of the battery module and the motor. Readouts from the sensors may be displayed via the user interface. Additionally, or alternatively, sensor readouts may include information pertaining to the battery module (e.g., charge level, charge cycles remaining, live amperage meters, an efficiency meter, etc.). In some embodiments, an efficiency meter may be displayed on the user interface that displays operational efficiency of the electric motorbike. For example, the meter may display different color schemes based on how much power is being drawn during operation (e.g., red/yellow/green).

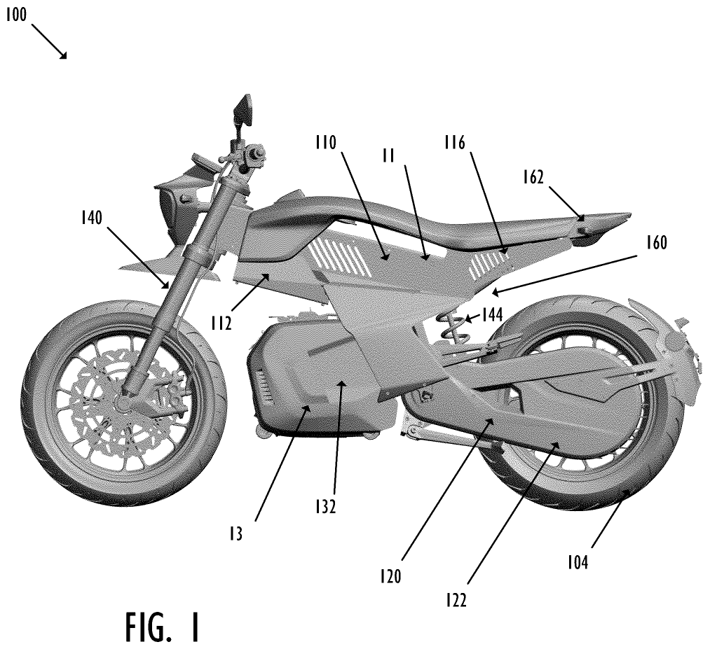

In describing examples of individual components, orientation references such as “front”, “upward”, “forward”, “rear”, “rearward”, “top”, “bottom”, and “lateral” (or “side”) are made in context of those components being operatively assembled as part of an electric vehicle such as described with FIG. 1.

FIG. 1 illustrates an electric motorbike 100, according to one or more embodiments. As described, some examples provide for the motorbike 100 to be formed from modularized component assemblies. Further, the motorbike 100 (or component assemblies thereof) can be formed from manufacturing processes that optimize efficiency, as well as modularization or interchangeability of components. Still further, examples provide for the motorbike 100 to be formed from component assemblies that simplify or otherwise minimize the number of steps required by final assembly, where component assemblies are assembled to form a functioning motorbike 100 or other vehicle.

In some embodiments, the electric motorbike 100 includes component assemblies that include a central frame assembly 110, an electric motor drive assembly 120, and a battery assembly 130. Additionally, the motorbike 100 includes a front assembly 140, lighting assembly 150 and seat assembly 160.

In an example shown, the central frame assembly 110 includes frame segments 112, 114, 116 that are structured to support a rider and maintain structural integrity of the motorbike 100 in use. The central frame assembly 110 can also include side segments that are configured to contribute to the structural integrity of the motorbike 100 while providing additional support for the rider (e.g., leg positioning), as well as debris protection for the motorbike 100 when it is in use. In an example shown, segments or portions of the central frame assembly 110 (such as shown by frame segments 114, 116) directly support a seat structure 162 of the seat assembly 160.

In examples, the motorbike 100 includes frame structures that are formed from sheet metal plates that are cut and/or connected to other sheet metal plates using rivets. In some variations, the frame segments 112, 114, 116 are planarized, such that a substantial portion of individual frame segments is planar. Such planar segments can include, for example, L-shaped and U-shaped structures.

The electric motor drive assembly 120 includes a motor drive frame 122 to house an electric motor and drive assembly (not shown in FIG. 1). The battery assembly 130 can include a battery frame 132 and battery module (not shown in FIG. 1). A shock absorber 144 can also be provided at a rear of the motorbike 100 to dampen against oscillations and support the rider.

In examples, at least some of the component assemblies of the motorbike 100 are formed from independent manufacturing processes. Still further, in some examples, at least some component assemblies may be modularized, meaning that component assembly can be used with different motorbikes (e.g., motorbikes with different specifications, electric motors, capabilities or dimensions) or different types of vehicles (e.g., all terrain vehicle, snow mobile, etc.). For example, as described with embodiments, the electric motor drive assembly 120 can be manufactured to form a rear drive unit for alternative types of electric vehicles.

Still further, in some examples, the processes for assembling component assemblies can be modularized, meaning that, for a given component assembly, at least a majority of the steps or component elements that are used to assemble component assemblies for different products or product configurations are the same. In such cases, component assemblies as described can be produced for alternative products or product configurations with relative minor adjustments to one or more elements of the component assembly and/or with relatively minor adjustments to one or more steps in the process for manufacturing the component assembly.

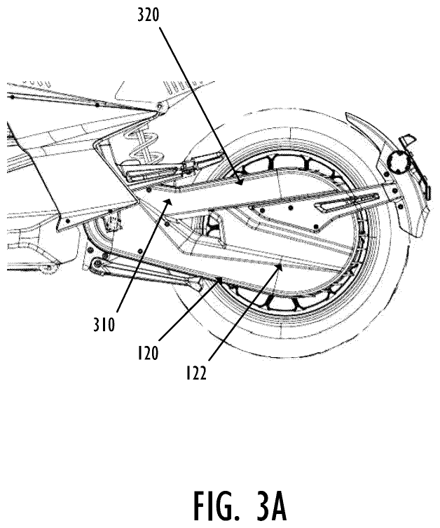

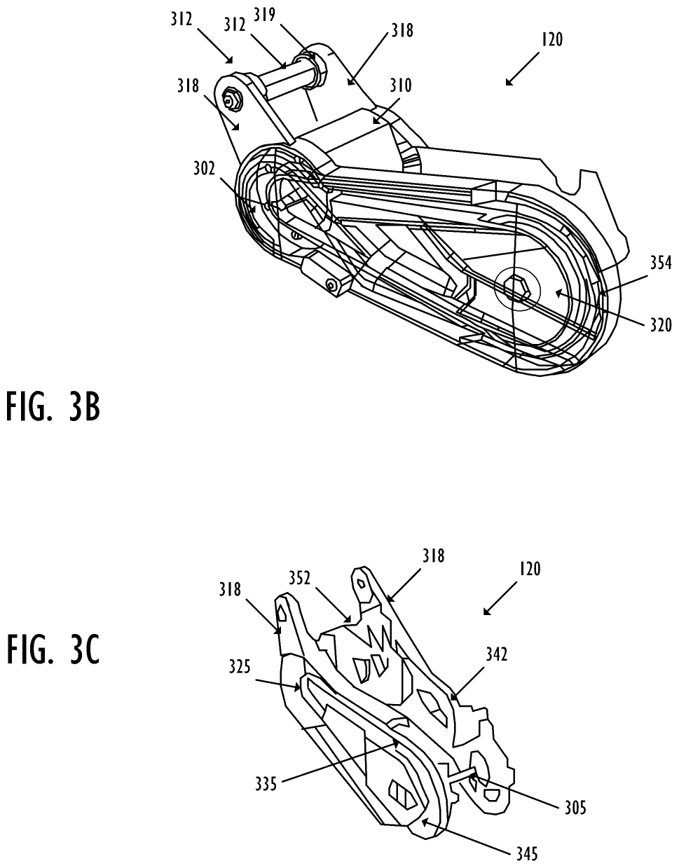

As described with examples of FIG. 3A, the electric motor drive assembly 120 houses an electric motor and belt drive assembly. The electric motor drive assembly 120 further includes an arm segment or portion that extends rearward to connect to a rear wheel 104 of the motorbike. In some examples, the arm segment or portion can form a swing arm for the motorbike 100 while housing the belt drive assembly to operate the motorbike 100.

In examples, the shock absorber 144 can be modularized, or assembled in a manner that enables the component to be replaced, repositioned or resized. The ends of the shock absorber 144 can be connected to segments of the frame assembly for the motorbike. The shock absorber 144 can mate to the frame assembly of the motorbike 100 at any one of multiple positions. For each such mating position, the corresponding frame segment of the motorbike can be provided with a corresponding set of openings that align to receive a rod, bolt or other connector member. Such connector member can serve to secure the shock absorber 144 to the frame assembly of the motorbike. In one implementation, a set of three opening pairs are formed on the central frame assembly 110, each opening pair being aligned to receive a connecting cross-bar that also affixes to an end of the shock absorber 144. The set of openings can be arranged in an arc, so to be provided at different heights and distances from a base member where the shock absorber 144 is to be anchored. During the manufacturing process, the shock absorber 144 is selected for attributes such as size, dampness, rigidity, etc. Based on its dimensions, the shock absorber 144 is secured to the anchor (base) and connected to the frame assembly of the motorbike through an opening that is appropriate for the specific attributes of the shock absorber 144. The shock absorber 144 can also be non-destructively removed from the motorbike 100 for a replacement, including a replacement that has a different set of attributes.

In examples, one or more of the frame segments 112. 114, 116 can provide a set of fastener elements 115 that are accessible to end-users. In some examples, the fastener element 115 that is a torque-locking receptacle. In implementation, the set of fastener elements include one or more through hole nuts that are press-fitted into apertures of the frame segment 114 during a manufacturing/assembly process. The user can access the fastener element 115 to mate an accessory device (e.g., travel bag or basket) to the frame of the motorbike 100. In this way, the user can attach and detach an accessory device from the motorbike. In examples, the fastener element 115 can receive a threaded insertive connector (e.g., bolt). An accessory device can be provided with threaded connectors that are positioned to align and mate with the motorbike 100. By way of example, the fastener element 115 can correspond to a stainless steel through hole nut screw, such as manufactured under the trade name PEM.

### Frame Assembly Process

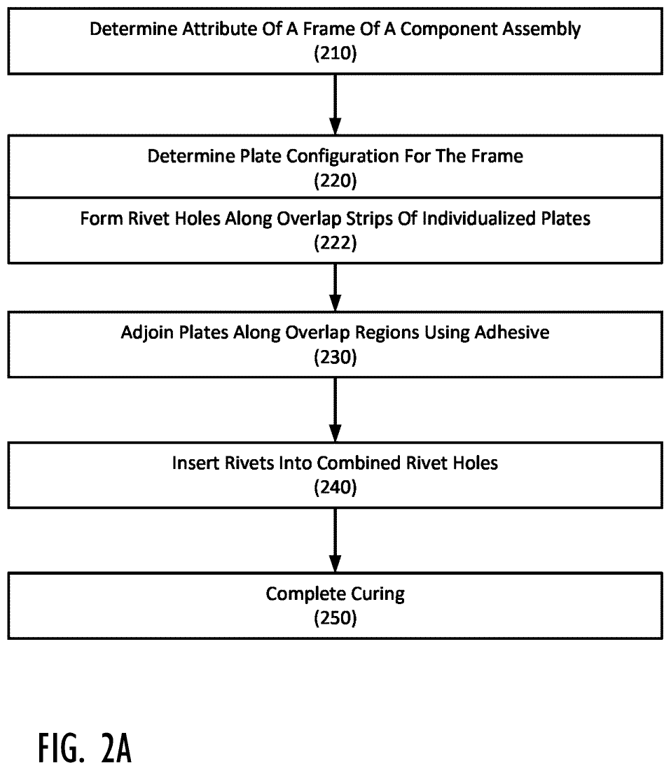

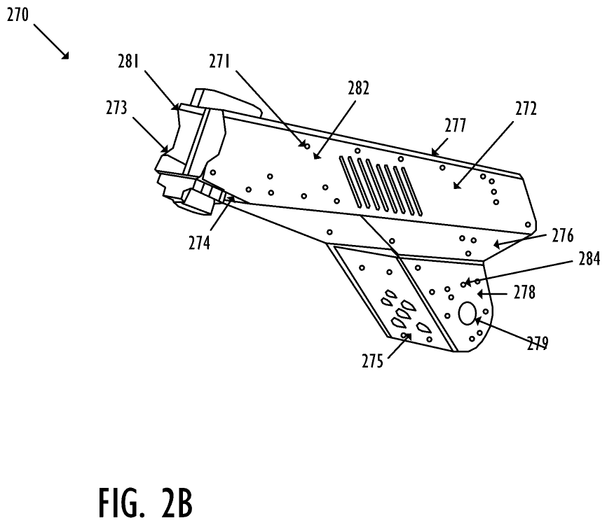

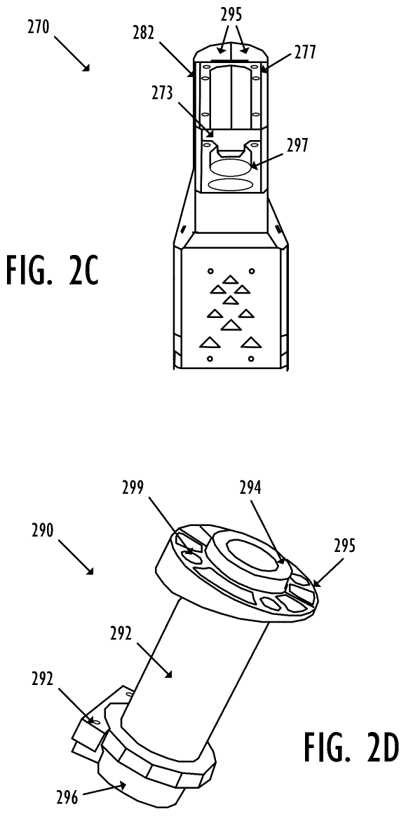

FIG. 2A illustrates a frame assembly process for manufacturing a frame or frame component for a component assembly of a vehicle, according to one or more embodiments. A process such as described with FIG. 2A can be used to assemble or manufacture component assemblies, such as shown and described with FIG. 1 and other examples.

At (210), the attributes for a frame of a component assembly is determined. For example, the dimensions, weight, strength attributes and other attributes of the frame are predetermined, based at least in part on the requirements of the component assembly and the vehicle which is to receive the component assembly.

At (220), a plate configuration sub-process is performed to determine a plate configuration for the frame. The plate configuration for the frame can identify a number of plates, plate attributes (e.g., plate material and thickness), plate geometries and plate overlap strips. Each identified plate of the plate configuration can be formed from sheet metal of a selected material and thickness.

In examples, the plate configuration sub-process generates specifications for a pattern of plate elements, including dimensional specifications that identify overall plate geometry (e.g., shape and size) and overlap strip dimensions for individual plates of the pattern. Further, at least some plates of the geometry include one or more overlap strips, where each overlap strip identifies boundaries of regions on a surface of the plate that is to make contact and adhere to an overlap strip of another plate of the pattern. In examples, the plates are pre-manufactured from select material (e.g., type of steel alloy) to have, for example, a particular thickness, dimension and shape (e.g., flat panels, curved panels, etc.). The desired plate geometries can be implemented through, for example, a CNC machine, which cuts, bends and folds sheet metal into desired shaped plates.

In some examples, the plate configuration sub-process can determine shape (e.g., cut, bend, fold) and relative position of individual plates, to yield a desired three-dimensional frame having a desired shape and set of attributes. This resulting plate pattern can define a shell with an interior void, where individual plates can be jointed to other plates in accordance with a pattern to form a portion of the shell in one, two, or three dimensions. In this way, individual plates can be said to be “stitched”, meaning the plates are joined in sequence and/or as puzzle pieces with respect to other plates of the frame. In this way, the resulting plate pattern can identify overlapping strips, where individual plates are adjoined to other plates using adhesives.

In examples, the plate configuration sub-process is computer-implemented. The computer-implemented process can further optimize the design of frame components for objectives such as minimizing plates or material and/or reducing the area of overlapping strips.

At (222), rivet holes are formed along the overlap strips of the individual plates. The rivet holes can be spaced or otherwise positioned based on specifications for the desired frame. In examples, the rivet holes are implemented at the same time the sheet metal is being cut and shaped (e.g., by the CNC machine).

At (230)), the plates are adjoined along their respective overlap strips. The plates may, for example, be adjoined in accordance with a sequence where individual plates are adhered to other plates along predetermined overlap strips. The plates may also be adhered such that rivet holes of adjoining plates align or overlap, to form combined rivet holes. A suitable manufacturing adhesive can be selected to adjoin the plates.

At (240), rivets are inserted into the combined rivet holes of the adjoined plates. The rivets may be machine-inserted while the adhesives that join the plates are being cured. For example, the rivets may be inserted seconds are minutes after the plates are adjoined. The machine-inserted rivets can be inserted in a manner that forces out the adhesive between the plates.

At (250), the frame is allowed to cure with inserted rivets for a specified duration (e.g., 24 hours) before assembly of the frame is deemed complete.

FIG. 2B illustrates construction of an example front frame segment, in accordance with one or more embodiments. A front frame segment 270) (which can correspond to central frame 110 of FIG. 1) supports the front assembly 140 of the motorbike 100. In examples, the front frame segment 270) receives a head tube component 244 of the 100. The head tube component 244 can provide handlebars 245, user controls, forks, wheel assemblies and other components, as shown and described with examples.

In examples, the front frame segment 270) can be designed to have an overall shape and set of attributes (e.g., material, strength, overall dimension, etc.). The plate configuration sub-process is implemented to identify plates 272, 274, 275, 276 and 278. Each of the plates 272, 274, 275, 276 and 278 can have a particular shape, formed from cutting and folding the edge surfaces. Additionally, each plate 272, 274, 275, 276 and 278 can include overlap strips, where individual plates are adjoined to other plates. The plates 272, 274, 275, 276 and 278 can be adjoined, in accordance with a plate pattern where the plates are shaped to form a portion of the overall frame design. Rivets 271 are formed in regions that coincide with overlap strips (where adjoining plates 272, 274, 275, 276, 278) adhere and adjoin to one another). As described, rivet holes may initially be formed along the overlap strips, and once the plates are adjoined using adhesives, the rivets are machine-inserted into aligned rivet holes of adjoined plates. The resulting structure forms a frame (e.g., central frame 110) for the motorbike 100 or other vehicle.

Further, in examples such as shown, a connector hole 279 can be formed within the front frame segment 270) to receive a cross-bolt or rod. The connector hole 279 can be aligned with a similar shaped hole of another assembled segment, so that the respective connector holes of the aligned frame segments can receive a connector rod (e.g., bolt). In this way, the connector rod or bolt can be passed through the connector hole 279 and secured in place through threaded fasteners or the like.

### Modular Headtube Assembly

With further reference to FIG. 2B through FIG. 2D, embodiments provide for the front assembly 140 to include a modularized headtube component 290 that can be assembled onto the frame assembly of the motorbike 100, either during the course of manufacturing the electric motorbike, or post-manufacturing (e.g., such as by the end user). Among other advantages, through modularization, a headtube component 290 can be assembled onto the 100 without welding. As with other examples, welding complicates the manufacturing process, as by reducing acceptable tolerances as between the alignment of components, and by requiring use of specialized equipment. Additionally, modularization allows for a given type of frame assembly (e.g., frame assembly for different size or types of motorcycles) to be outfitted with different types of headtube components 280. Likewise, a given type of headtube component 290 (e.g., length, head-angle, with/without suspension, type of suspension, etc.) can be assembled onto frame assemblies of different types.

With reference to FIG. 2B and FIG. 2C, the frontal frame segment 270) includes a front extension 282 that extends forward from a respective base portion 284. The front extension 282 can be defined at least in part by the plates 272 (side plate), 273 (side plate), 274 (bottom plate) and 277 (top plate). At or near a frontal end 281, the front extension 282 can include an opening to receive a main body 292 of a headtube component 290. In some implementations, the top plate 277 includes a circular opening that is dimensioned to receive the top end portion 294 of the headtube member 292. In some examples, headtube member 292 passes through openings of top and bottom plates 277, 274, where it is secured by fasteners and without welding.

As shown by FIG. 2D, the headtube component 290 includes a main body 292 having a top end portion 294 and a bottom end portion 296. A set of plate connectors 295 can be provided at the top end portion 294. In an example shown, the set of plate connectors 295 include plate segments that individually define a semi-circular opening. Each plate connector 295 can include rivet holes 299 that overlap and align with respective rivet holes of the top plate 277. The plate connectors 295 can be secured to the top plate 277 such that the two plates define an opening to receive the main body 292 of the headtube component 290. The interior thickness of each plate connector 295 can be structured (e.g., threaded) to secure and affix the top end portion 290 of the headtube component 290. According to some examples. during assembly, the main tube 292 is inserted from the bottom of the front extension 292, such that the top end portion 284 passes through the top plate 277, where it is affixed by the plate connectors 295. The plate connectors 295 can be secured to the top plate 273 of the front extension 282.

Further, with reference to FIG. 2C and FIG. 2D, in examples, the bottom end portion 296 of the headtube component 290 can be secured to the bottom plate 273 of the front extension 282 by a collar 298 or collar assembly. In an example, a collar extension 297 can extend from the bottom plate 273. The bottom portion end 296 of the headtube component 290 can be received in the collar extension 297. The bottom end portion 296 can be threaded, along with the collar 298. As an addition or variation, the bottom end portion 296 may extend from the bottom plate 273, such that the threaded portion is exposed, to receive the collar 298. The collar 298 can be mated to affix the bottom end portion 296 to the underside of the bottom segment 273. In this way, the headtube component 290 can be assembled and affixed to the respective frame assembly. Further, in some examples, the headtube component 290 can be detached from the frame assembly of the motorbike 100 non-destructively, through application of mechanical force (e.g., torque to collar 298 and to top end portion 294).

### Electric Motor Drive Assembly and Frame

FIG. 3A through FIG. 3C illustrates electric motor drive assembly 120, according to one or more embodiments. With reference to FIG. 3A, the electric motor drive assembly 120 is shown as assembled on an electric motorbike 100. The electric motor drive assembly 120 includes motor drive frame 122, structured as a shell having a main segment 310 and an arm segment 320. The main segment 310 is configured to house an electric motor, and the arm segment 320 is configured to house a belt drive assembly. In some variations, the main segment 310 is dimensioned to house any one of multiple electric motors or electric motor combinations of alternative dimensions, power output and performance attributes. The arm segment 320 extends rearward from a lateral portion of the main segment 310. In some examples, the arm segment 320 is dimensioned and structured to form a swing arm for the electric motorbike 100. The electric motor drive assembly 120 can also form a support structure for the shock absorber, to support a seated rider.

FIG. 3B is an isolated view of the electric motor drive assembly 120 with a lateral portion of the exterior shell cut away, to illustrate the operation of a covered belt drive system. The main segment 310 includes a cylindrical body having end segments 302. The main segment 310 is structured to house an electric motor 352 (see FIG. 3C) that powers the motorbike 100. Accordingly, the main segment 310 is dimensioned to retain one or more electric motors 352 of a desired dimension. Additionally, the arm segment 320 extends rearward along a lateral side of the electric motorbike 100 to engage a rear axle and wheel assembly of the motorbike 100. The arm segment 320 houses a belt drive system 354 that combines with the electric motor 352 to form a rear drive unit for the motorbike 100

In examples, shaft 325 of the electric motor 352 (FIG. 3C) extends from at least one of the end segments 312 of the main segment 310 into the interior of the arm segment 320, to engage a belt drive assembly 354. The shaft 325 engages shaft wheel (not shown), which is connected by belt 355 to a flywheel 345. The flywheel 345 is connected to or otherwise forms part of a back wheel assembly of the motorbike 100. When powered by the electric motor 352, the belt drive assembly drives the rear axle to spin the rear wheel and cause the motorbike 100 to propel forward.

The electric motor drive assembly 120 also include a parallel frame segment 342 that extends rearward on an opposite side of the arm segment 320. Additionally, the arm segment 320 and/or the frame segment 322 can also shield the belt drive system, axle and wheel of the motorbike 100 from debris when the motorbike 100 is in use.

With reference to FIG. 3B, main segment 310 is integrated with a frame support structure 312 that connects the electric motor drive assembly 120 with another frame structure of the motorbike 100. The frame support structure 312 include support flanges 318 openings 319 for receiving connecting rod 316. In examples, the openings 319 are aligned with corresponding openings of the central frame assembly 110 to receive the connecting rod 316. In this way, an example provides for the central frame assembly 110 to be securely assembled to electric motor drive assembly 120 using a single connector rod 316.

FIG. 3C is an isolated view of the electric motor drive assembly 120 with a portion of an exterior casing shown to be cut away. As shown, the electric motor 352 is mounted between support flanges 318, with the shaft 325 extending laterally to engage a shaft wheel of the belt drive assembly 354. In an example shown by FIG. 3C, the motor 352 includes fins 357 or other features to provide a heat sink for operation of the motor. The fly wheel of the belt drive assembly 354 engages an axel 305 of a rear wheel assembly. When the motor is operated, the shaft wheel is engaged and causes the fly wheel 345 to spin via the connecting belt 355. In turn the fly wheel 345 connects to a rear axle 305 to drive a rear wheel of the motorbike 100. The frame segment 342 can extend from the other lateral portion of the main body 310 to passively engage the rear axle 305. In this way, the frame segment 342 supports the electric motor drive assembly 120, while providing cover and protection against debris when the motorbike 100 is in use.

According to examples, the motor drive frame 122 is formed as an integrated assembly. In some examples, the motor drive frame is formed from cast aluminum. In variations, the electric motor drive frame 122 is assembled using a pattern of plates, such as described with examples of FIG. 2A and FIG. 2B.

In some examples, the electric motor drive assembly 120 is assembled during a manufacturing process that is separate and independent of the manufacturing process to assemble other components of the motorbike 100 or vehicle. Additionally, the electric motor drive assembly 120 can be modularized to accommodate, for example, different size electric motors or internal components. In variations, the process for assembling the electric motor drive assembly 120 can be modularized, in that, for example, design parameters for the electric motor drive assembly 120 can be changed. For example, the arm segment 320 can be lengthened or shortened to accommodate different form factors for the electric vehicle. Further, the adjustment to the length of the arm segment 320 can result in use of different size belts, or flywheels with different size dimensions. Among other advantages, modularizing the electric motor drive assembly 120 and/or the assembly process such as in the manner described allows for a manufacturing or assembly process that can produce alternative variations of a product (e.g., electric motorbike 100 with different performance attributes), as well as different types of products (e.g., electric motorbike, all terrain vehicle (ATV), go kart, etc.).

### Battery Assembly and Frame

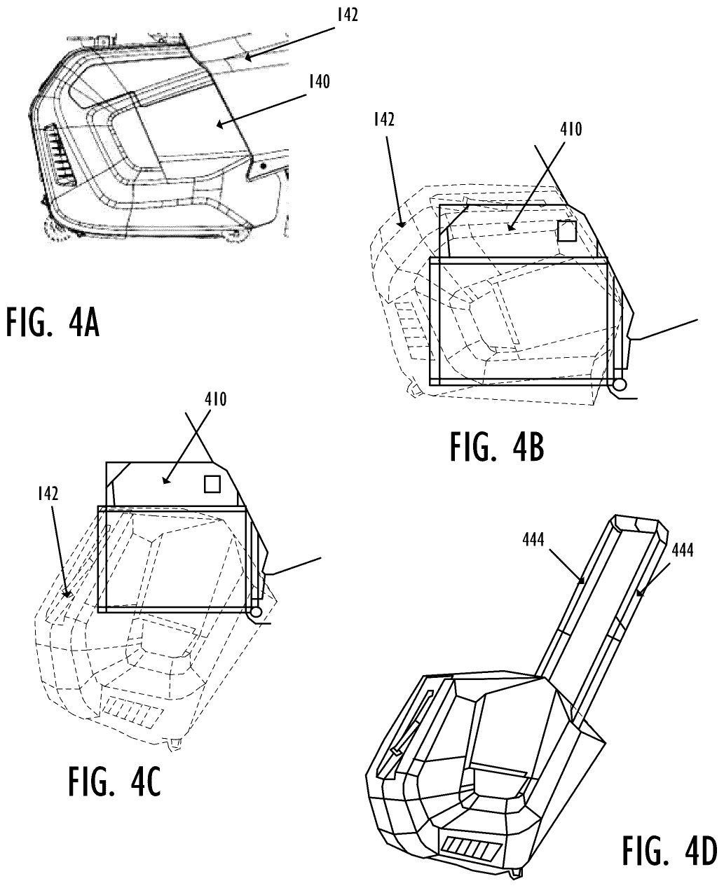

FIG. 4A through FIG. 4D illustrate battery assembly 140) and battery frame 142, according to one or more embodiments. The battery frame 142 can be manufactured through a process such as described with FIG. 2A and FIG. 2B. Accordingly, dimensions and other attributes of the 142 can be determined based on, for example, a size of the battery module 410 that is retained within the frame 142. The battery frame 142 can be formed from one or multiple plates of sheet metal which are cut, bended and folded in accordance with a predetermined design. Rivet holes can also be formed at the same time for any regions of the plate(s) that are to overlap. Adhesives may then be applied to those regions of the individual plates, and the plates may be overlaid along their regions in accordance to the plate pattern of the battery frame design. The plates may be adhered to one another along the overlaid regions, with holes on each plate being aligned to receive corresponding rivets. The rivets may be machine-inserted and the adhesive may then be allowed to fully cure.

FIG. 4B and FIG. 4C illustrate battery module 410 housed within the battery frame 142 (shown in phantom). The battery module 410 can be inserted and electrically mated with wires of a power buss that power components of the motorbike 100. In particular, the battery module 410 can power the electrical motor, lights, and auxiliary components of the motorbike 100. Further, the interior of the battery frame 142 can be provided with recharge circuit and outlet to receive an incoming power supply.

FIG. 4D illustrates an example in which the battery frame assembly 142 is detachable from the remainder of the motorbike 100. The battery frame assembly 142 can be provided with wheels and telescoping arms 444 (or handles) which can be extended when the battery frame assembly 142 is detached from the motorbike 100. When the battery frame assembly 142 is detached, the user can extend the telescoping arms and pull the battery frame assembly 142 with the battery module 410. Likewise, the user can contract the telescoping arms, connect the battery frame assembly to the motorbike 100, and cause the battery module 410 to electrically connect with the power buss of the motorbike 100.

### Seat Assembly

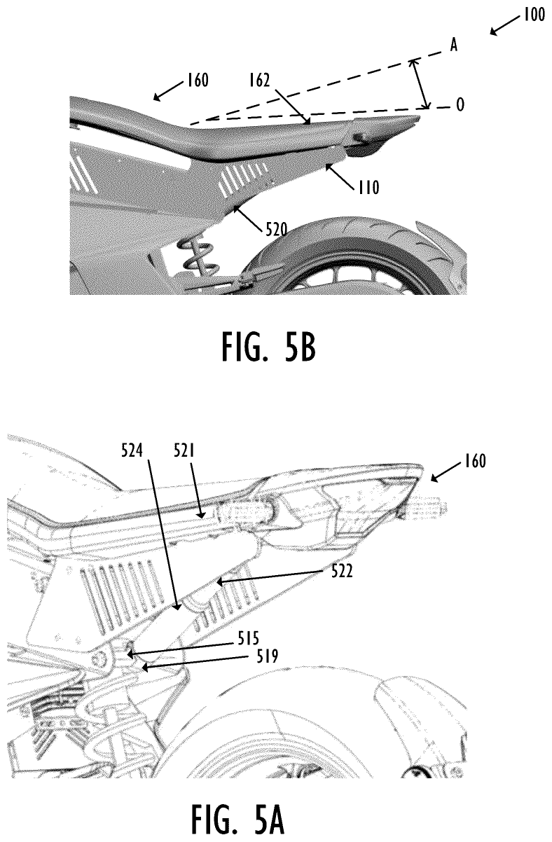

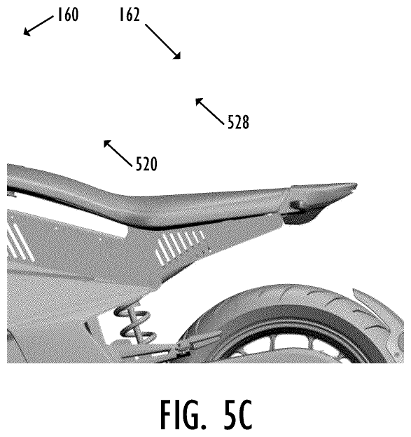

FIG. 5A through FIG. 5C illustrate example motorbike 100 having an adjustable seat assembly, according to one or more embodiments. FIG. 5A illustrates a bottom perspective view of the motorbike 100, including seat assembly 160 having a seat 162 and a pair of pneumatic cylinders 520. The seat 162 (and user on the seat) can be directly supported by the central frame assembly 110. Further, each of the pneumatic cylinders 520) include a bottom end 519 that mounds to a cross-bar 515 of the central frame assembly 110. In an example shown, the bottom ends 519 can correspond to engagement points of an insertion rod for each pneumatic cylinder 520.

Each pneumatic cylinder 520 includes an outer cylinder 522 and insertion rod 524 that moves axially within a volume of the outer cylinder between different axial positions. The insertion rod 524 of each pneumatic cylinder 520 connects to the cross-bar 515, and the base of the cylinders 520 connects to the bottom end 521. In variations, the configuration of the pneumatic cylinders 520 can be different (e.g., insertion rod 524 connects to the underside 521 of the seat 162). The insertion rod 524 is partially inserted within a sealed chamber of the outer cylinder and moveable between alternative vertical positions based on the distribution of gas/fluid within the sealed chamber. Each pneumatic cylinders 520 can further include a control mechanism that controls the axial position of the insertion rod 162, to cause axial repositioning of the insertion rod 524 relative to the outer cylinder 522. For example, the control mechanism can be manipulated to cause the insertion rod 162 to move axially outward (e.g., towards the cross-bar 515) relative to the outer cylinder 522, thereby causing the pneumatic cylinder 520 to push out on the underside of seat 162, and further causing the seat to lift. The control mechanism can also be manipulated to cause the insertion rod 162 to move axial inward relative to the outer cylinder 522, thereby causing the seat 162 to lose height.

In examples, the pneumatic cylinders 520 are gas cylinders, and the position of the insertion rods 524 can be controlled through mechanical levers that cause distribution of the gas within the sealed chamber in a desired direction. Still further, in some examples, the position of the mechanical levers can be controlled by control cables that are positioned at or near the handlebars of the motorbike 100. Alternatively, control cables can be provided in alternative locations on the central frame assembly 110 or sear assembly 160. In variations, the pneumatic cylinders 520 utilize alternative forms of pneumatics, and the control mechanism can be electrically actuated to cause movement of the respective insertion rods 524.

FIG. 5B is a side view of the motorbike 100, illustrating a range of motion for the seat 162, responsive to adjustments of the pneumatic cylinders 520. In an example shown, the seat 162 of the seat assembly 160 can travel from an original position (O) to an adjusted or raised position (A), and from the adjusted or raised position (A) back to the original position (O). In some examples such as shown by FIG. 5A and FIG. 5B, the movement of the seat 162 can be along an arc.

While an example of FIG. 5A and FIG. 5B illustrate the motorbike 100 including a pair of pneumatic cylinders 520, in variations, more or fewer gas springs may be used. Further, in other variations, electro-mechanical actuators may be used in place of gas springs 520 to enable the seat 162 to rise to the adjusted position (A) and/or fall to its original position (O).

FIG. 5C is an isolated view of seat assembly 160, according to one or more embodiments. The seat assembly 162 includes seat 162, pneumatic cylinders 520 and base structure 528. The seat assembly 160 can be assembled through a separate process from other component assemblies of the motorbike 100. Elements of the seat assembly 160 can also be modularized to enable alternative seat assemblies to be readily assembled on the same motorbike 100 or vehicle design, as well as to enable the seat assemblies of the same design to be mounted on alternative vehicle designs. To assemble the seat assembly 160, the base structure 528 can be assembled through, for example, a process such as described with FIG. 2A. Further, the dimension of the base structure 528 can be varied to enable alternative seat dimensions and designs. Further, the seat 162 can vary in attributes (e.g., size, cushion thickness, etc.) from motorbike 100 (or vehicle) to motorbike/vehicle. Further, in modularizing the seat assembly 160, the process for creating the seat assembly 160 and/or elements of the seat assembly 160 can be varied based on, for example, the dimensions of the base structure 528 (which can vary based on user dimensions or preference, vehicle size or type, etc.). Still further, the type of pneumatic cylinders 520 and/or control mechanism can also be varied based on various factors, such as the dimensions or preferences of the user or the type of motorbike 100.

### Light Assembly

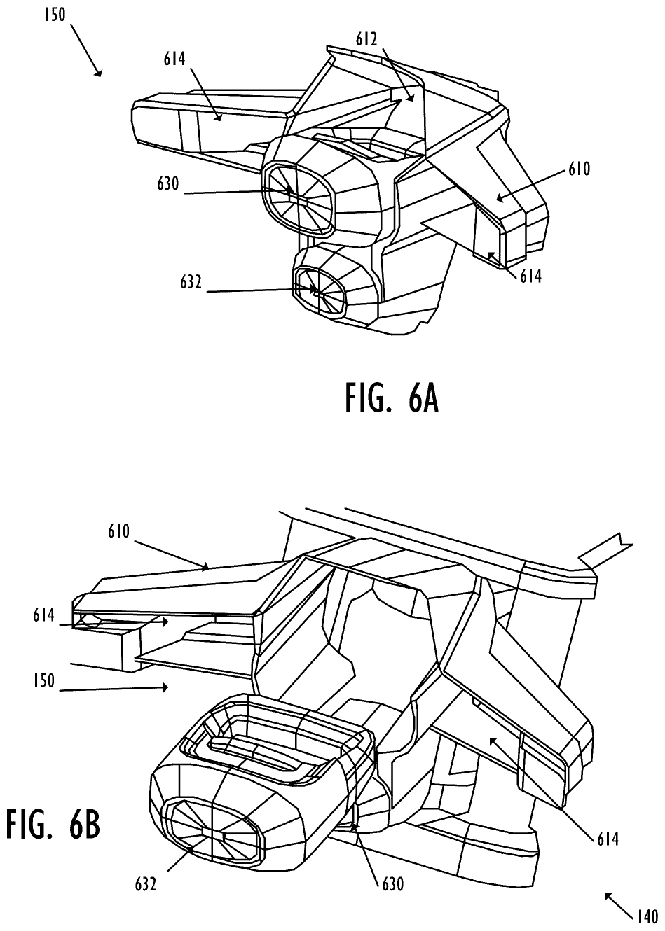

FIG. 6A and FIG. 6B illustrate a lighting assembly 150, according to one or more embodiments. The lighting assembly 150 includes a pair of light components 630, 632, where one light component (e.g., top light component 632) is auxiliary (e.g., high-beam, fog light). The lighting assembly 150 includes housing 610 to retain the light components 630. 632. The housing 610 can be shaped to include a base section 612, which is dimensioned to abut against (or in between) opposing bars of the handlebar assembly 140. The housing 610 can further include wings 614 that extend laterally outward from the base 612. As shown by an example of FIG. 6B, the housing 610 retains the pair of light components 632. Further, top light component 632 can be mechanically attached and detached from the interior of the housing 610) using. for example, one or more latch mechanisms. An interior of the housing 610 can include an interface that electrically connects to a power connector of the top light component 632 when that light component is fully inserted within the housing. The interface for the light component 632 can connect to, for example, the power buss for the motorbike 100.

In examples, one or both of the light components 630, 632 include batteries that can charge using power from the battery module 410 (or other power source connected to the power buss). Further, in examples, the top light component 632 can be de-latched or released from the housing 610, so as to operate as a portable and independent light component (utilizing interior rechargeable batteries).

In some variations, the battery of the light component 632 may also be used to charge other devices. Accordingly, the light component 632 can include one or more electrical ports to receive charging cables. Additionally, the light component 632 can power other auxiliary components, such as a music player or radio.

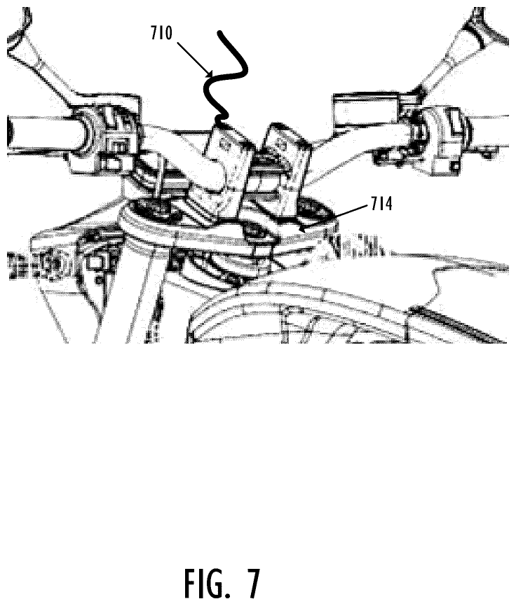

FIG. 7 illustrates a cable feature for use with handlebar assembly 140, according to one or more embodiments. The handlebar assembly 140 can include a section 714 which is provided an opening to store a cable 710. The cable 710 can be retractable and extendable from the section 714. When extended, the cable can be wrapped through or around the user's helmet (e.g., via openings formed in the helmet) or used to hold other items. An end point of the cable 710 can be inserted into a locking receptacle, which can be integrated with the handlebar assembly.

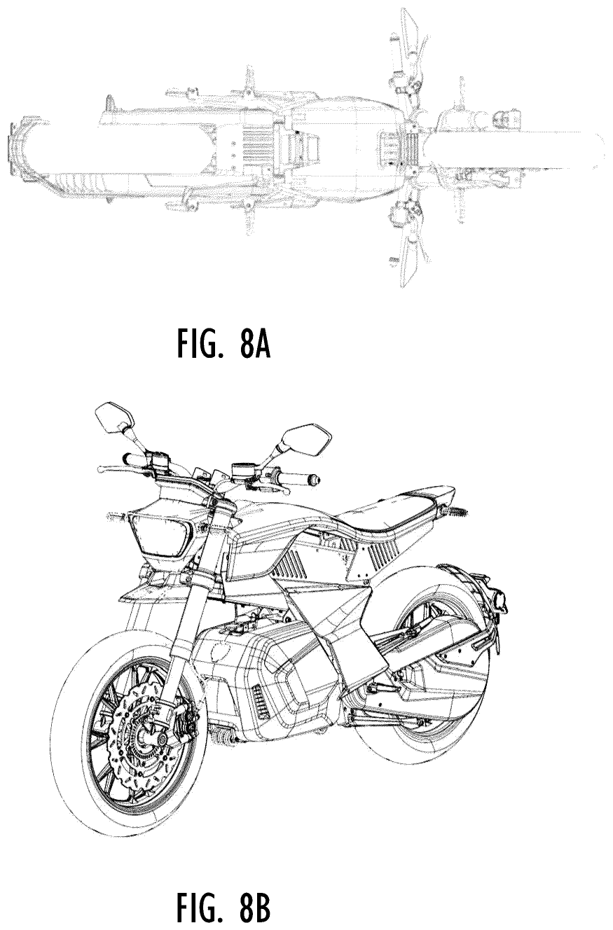

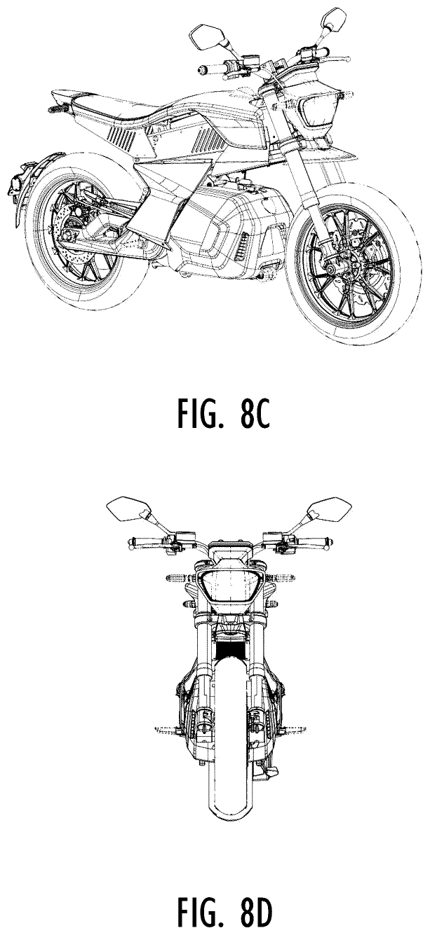

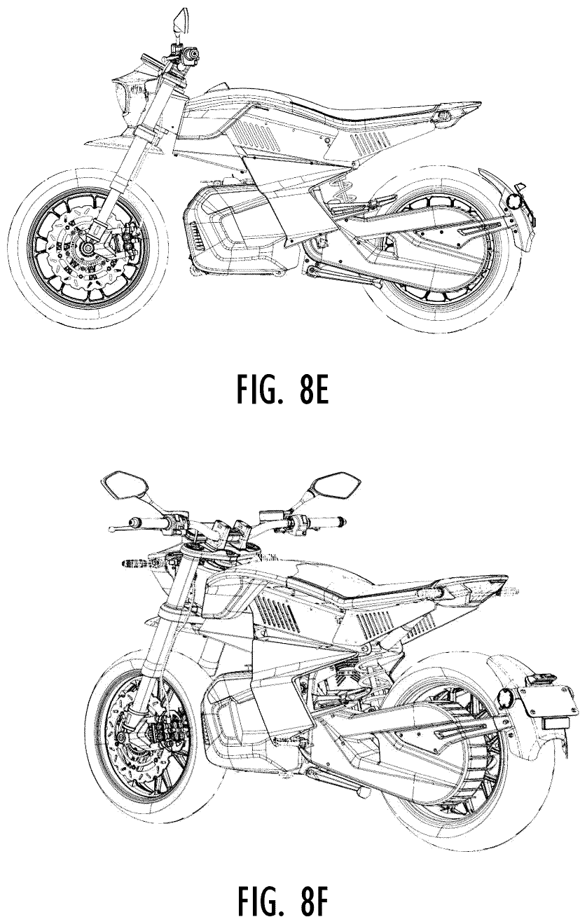

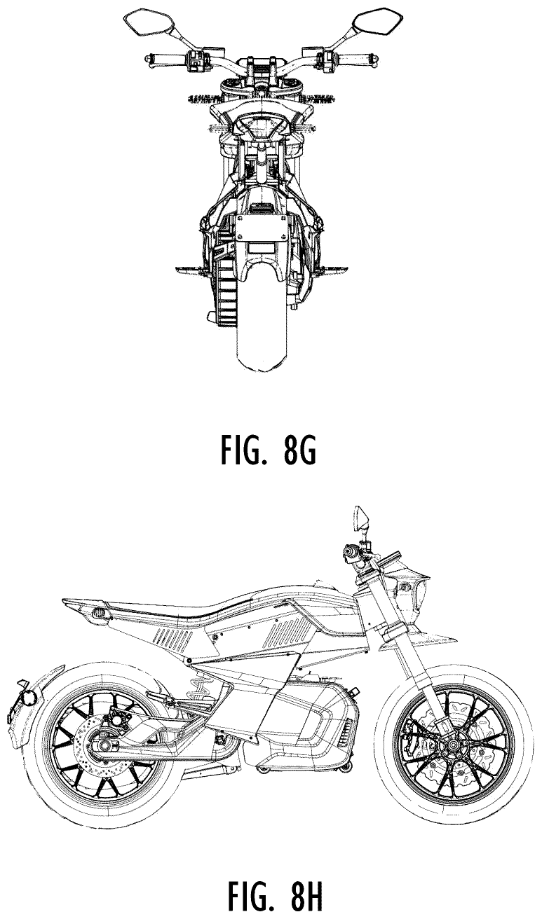

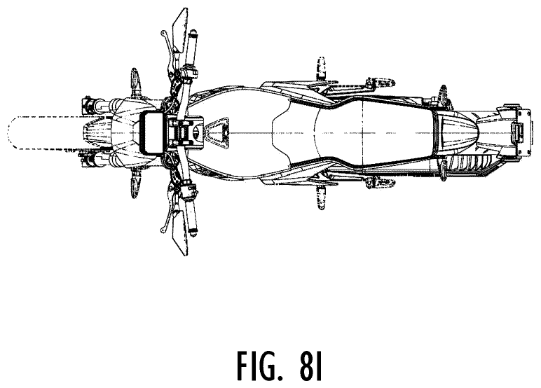

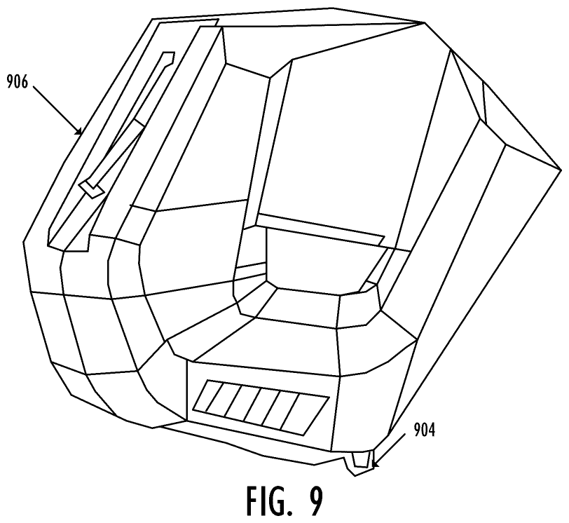

FIG. 8A through FIG. 8I illustrate alternative views of an electric motorbike, according to one or more embodiments.

In at least one alternative embodiment, FIG. 9 illustrates a removable battery housing 900 to hold a battery module, such as battery module 410 described herein. The battery housing 900 can be manufactured through a process such as described with FIG. 2A and FIG. 2B. Accordingly, dimensions and other attributes of the frame can be determined based on, for example, a size of the battery module 410 that is retained within the battery housing 900. The battery housing 900 can be formed from one or multiple plates of sheet metal which are cut, bended and folded in accordance with a predetermined design. Rivet holes can also be formed at the same time for any regions of the plate(s) that are to overlap. Adhesives may then be applied to those regions of the individual plates, and the plates may be overlaid along their regions in accordance to the plate pattern of the battery frame design. The plates may be adhered to one another along the overlaid regions, with holes on each plate being aligned to receive corresponding rivets. The rivets may be machine-inserted and the adhesive may then be allowed to fully cure.

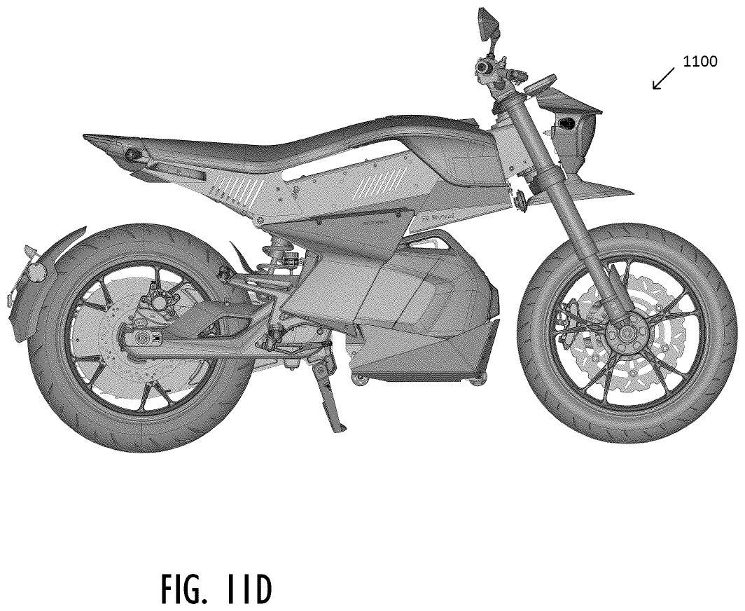

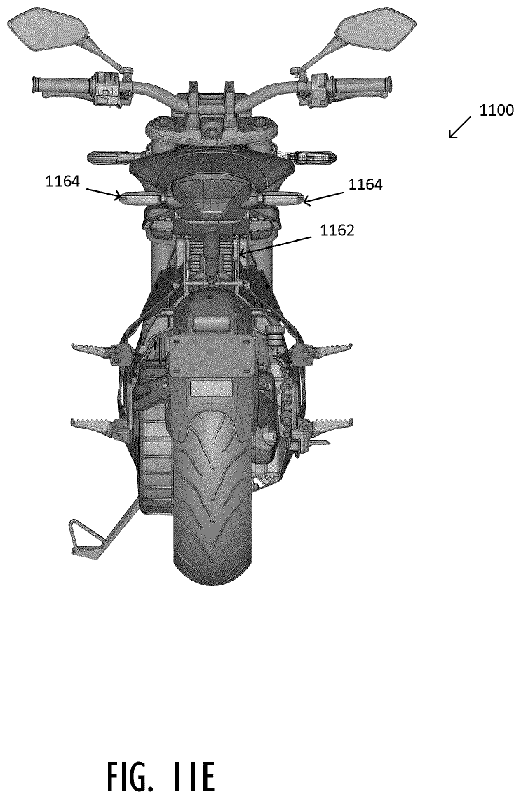

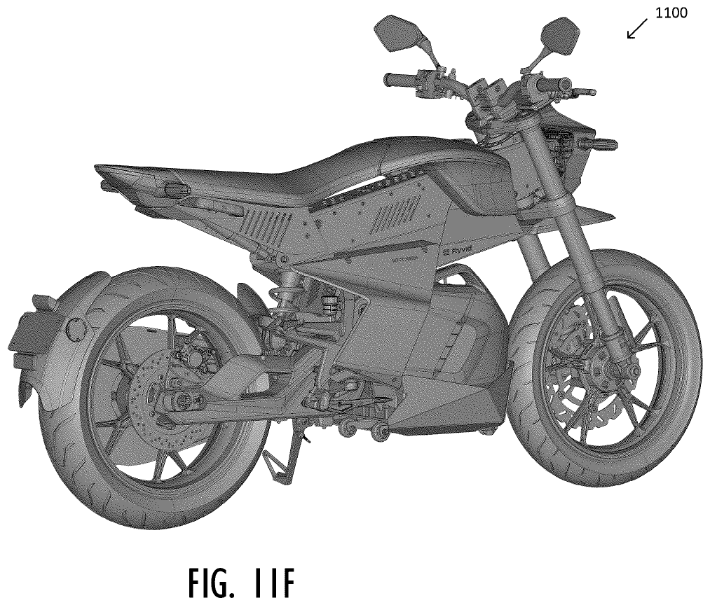

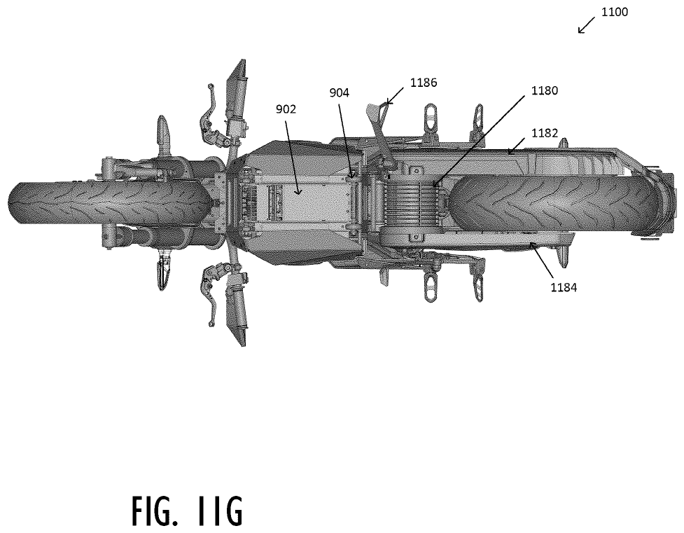

A battery module 410 may be housed within the battery housing 900. The battery module 410 can be inserted and electrically mated with wires of a power buss that power components of the motorbike 1100. In particular, the battery module 410 can power the electrical motor, lights, and auxiliary components of the motorbike 1100. Further, the interior of the battery frame 142 can be provided with recharge circuit and outlet to receive an incoming power supply. For example, in some embodiments, battery housing 900 may house a custom battery and include one or more skid plates 902 and wheels 904. The battery may be, for example, a 4.3 kWh lithium-ion battery that provides 84 V when fully charged. The battery module may last approximately 1,200 charge cycles before the battery is reduced to 80% capacity at full charge. Skid plates 902 may be provided on the underside of the motorbike to protect the battery module within the housing during operation of the motorbike. The skid plate may be comprised of hard anodized aluminum. A bottom view of the battery housing 900 and skid plate 902 is shown in FIG. 11G. Wheels 904 may be omni wheels to allow for easy transport of the battery housing when detached from the motorbike in any direction. The battery housing 900 may be removed from the electric motorbike by unlocking an over-center latch on top of the battery. Additionally, a secondary safety latch may be unlocked. Once unlocked, the battery housing rotates downwards and can be fully removed after disconnecting cables. The battery housing may then be eased off the bracket and onto the ground. The battery housing may include side handles 906.

Battery housing 900 may include an integrated charger or a high speed charger. The battery module may be charged while on the motorbike or removed and charged separately. A 110 V supply or 220 V supply may be used. Additionally, or alternatively, a built-in charger may be provided on the battery itself. For example, the built-in charger may be a 3.3 kW charger that is integrated into the battery module. In this example, only a charging cord would be needed.

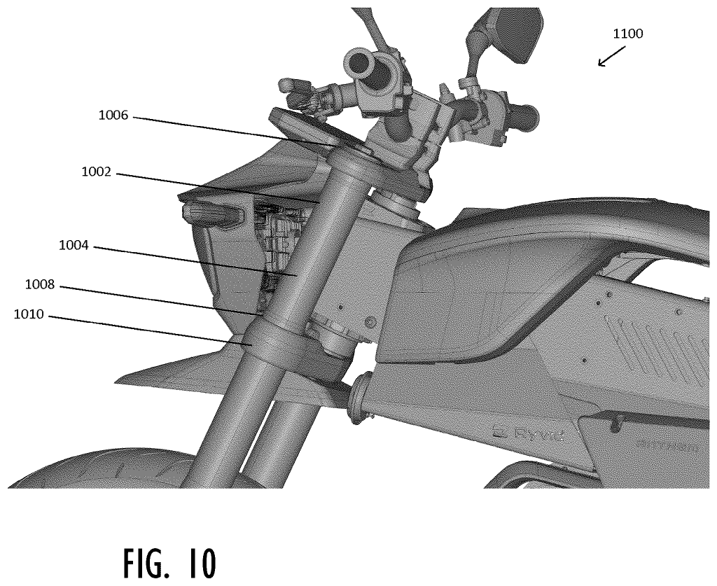

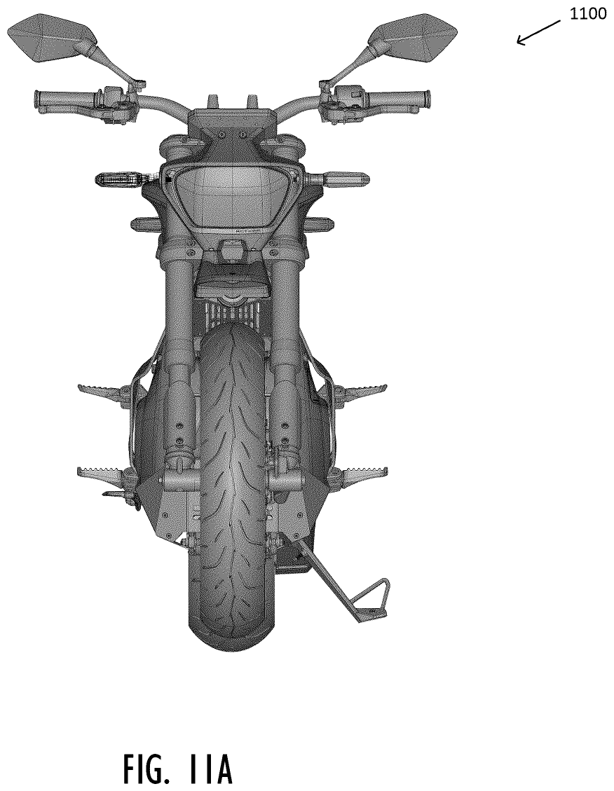

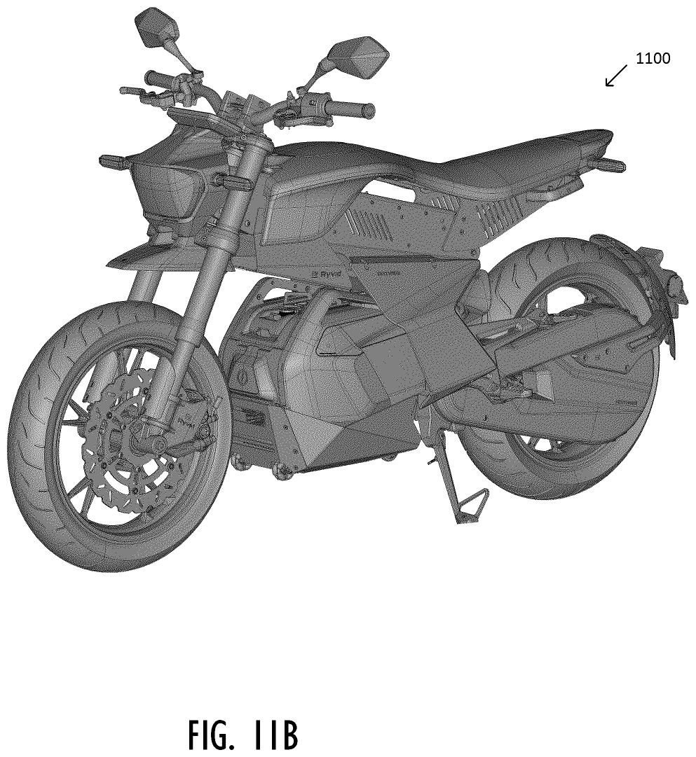

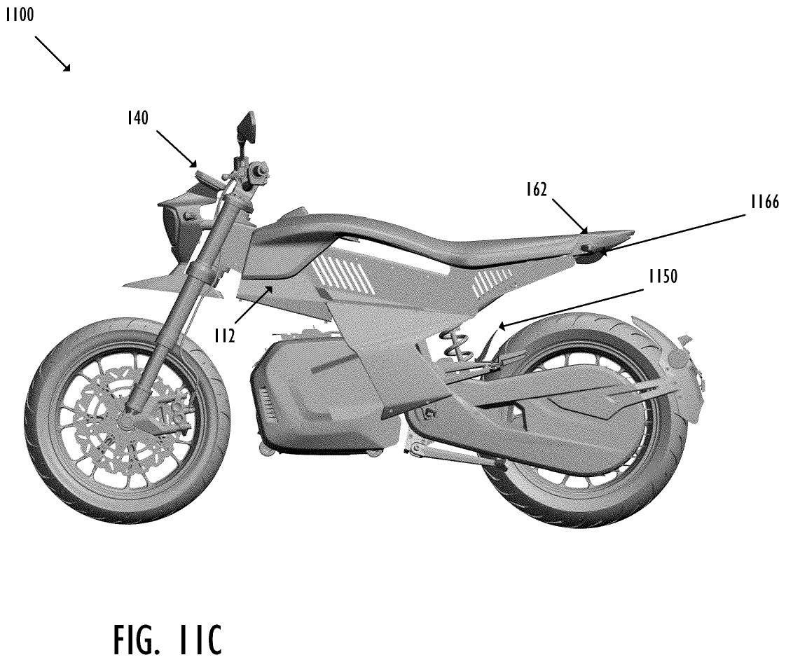

As shown by FIG. 10, a headtube component 1002 is shown. Headtube component 1002 may be, for example, similar to headtube component 290 of FIG. 2D. As shown by FIG. 10, the headtube component 1002 includes a main body 1004 having a top end portion 1006 and a bottom end portion 1008. The headtube component 1002 is secured by a collar assembly 1010 to the frame of the electric motorbike, as shown. In this way, the headtube component 1002 can be assembled and affixed to the respective frame assembly. Further, in some embodiments, the headtube component 1002 can be detached from the frame assembly of the motorbike 100 non-destructively, through application of mechanical force (e.g., torque to collar 298 and to top end portion 294). The headtube component may be a removable headtube. To prevent movement of the headtube, one or more clamps may be provided to secure the headtube in place. Additionally, a flat plate may be provided that goes between the collar and the frame that takes up the slack and cinches it down. The flat plate enables the use of a modular front end that is firmly put into place without the need for welding. In some embodiments, the headtube assembly consists of a 2 top retainer rings along with a squash plate and 2 bottom retainer rings that have a tapered flange. This prevents any movement between the front end and the frame allowing the headtube to be mechanically fastened instead of welded. Additionally, this enables the front end to be changed without replacing the entire frame.

FIGS. 11A-11G illustrate alternative embodiments of an electric motorbike 1100. Electric motorbike 1100 is similar in scope to electric motorbike 100, however motorbike 1100 includes modifications and variations of electric motorbike 100. As shown in FIG. 11C, electric motorbike 1100 includes a front fender and a splash guard 1150 to protect the rear shock assembly. As shown in FIG. 11E, electric motorbike 1100 includes reinforcement ribs and bracket assembly 1162 connected to the shock mount and rear seat adjustment mount. Brackets 1162 provide stiffness and functionality. Additionally, electric motorbike 1100 includes grab handles 1164 for a passenger to hold on to during operation. A skid plate 1166 is provided to protect the rear light housing assembly. For example. during operation of the electric motorbike. if the motorbike were to hit a pothole. the skid plate 1166 may protect the rear light components from being hit by the wheel.

As shown in FIG. 11G. electric motorbike 1100 includes a motor casing 1180 that may be mounted to swing arm sides 1182 and 1184. Motor casing 1180 may be detached from the electric motorbike 1100, such as for replacement. via connectors with the swing arms 1182 and 1184. Electric motorbike 1100 includes a kickstand 1186, which may be mounted to swing arm 1182. The kickstand 1186. in this embodiment, is part of swing arm 1182. The electric motor may include one or more built-in cooling fins that may be integrated with swing arm 1182. swing arm 1184. or both. The cooling fins may. in some embodiments. rotate with the swing arm to prevent belt slack and overall belt service life. Electric motorbike 1100 includes a built-in suspension mounting point which simplifies how the rear wheel is installed. Cooling of the motor 1180 is kept active based on the location of the cooling fins. which run along the bottom side, as shown in FIG. 11G. As the motor rotates with the swing arm and rear wheel, the belt. once tensioned and has no slack. the entire unit rotates together and results in perfect belt tension.

In a first embodiment. an electric motorbike is provided. The electric motorbike may include. for example, a metal frame formed by foldable metal (e.g., stainless steel) that is mechanically fastened together. The metal frame may comprise of stainless-steel material that is folded during manufacture to form the frame for the motorbike. The stainless-steel material may be 2.5 mm thick. Panels of the metal frame may be mechanically fastened together to reinforce portions of the frame. The electric motorbike may include an electric motor connected to swing arms on either side and a rear wheel. The electric motor may include cooling fins which run along the bottom side of the motor to prevent the motor from overheating during operation. A belt is connected between the electric motor. swing arms. and the rear wheel. The belt is tensioned with no slack so that the entire unit rotates together. In the first embodiment. the electric motorbike includes a removable battery and battery housing. The battery housing may be comprised of foldable metal materials (e.g., stainless steel) and reinforced to protect a battery module within the housing. In some embodiments. the battery housing may include wheels for easy transport of the housing when removed from the electric motorbike. Additionally. the battery housing may be reinforced with one or more skid plates to protect the battery module during operation of the electric motorbike. The battery housing and module may include an integrated charging system. Additionally, or alternatively, the housing may include one or more sensors that provide measurements of the battery, such as battery life, current charge level, battery usage, temperature, or the like.

Continuing with the first embodiment, a seat adjustment actuation system of the electric motorbike is provided. The seat adjustment actuation system may include push button operation, such as via the handlebars of the electric motorbike. A rider of the motorbike, while seated on the motorbike, may activate the button to move the seat of the motorbike up and down.

Continuing with the first embodiment, one or more computing systems may be provided for operation of the electric motorbike. Example computing systems include but are not limited to device control (e.g., lighting assembly, seat actuation), display control (e.g., user interface to provide readouts of sensor readings), a passive entry security system (e.g., key fob for starting/stopping bike, motor prevents bike from being rolled away or stolen).

The disclosed electric motorbike may include a plurality of computer devices that may be communicatively coupled to each other for operation of the motorbike. Example computer devices may include but are not limited to a computing device with a display and display controller, a motor controller, a battery controller, and a passive entry security system.

In some embodiments, a regenerative braking system may be provided for the electric motorbike. The electric motorbike may include a 74 amp max regen current. The amount of regen usable by default may be pre-determined. When the electric motorbike is in a first mode, such as a Sport mode, the regen is not linked to the throttle. When the throttle is not engaged, regen will not be activated. Instead, a regen button may be provided on the motorbike's handlebar is active in this mode. When the electric motorbike is in a second mode, such as an Eco mode, regen may be linked to the throttle, which means that when the throttle is not engaged, regen will be activated. The regen button is not active in this mode. In both modes, regen can be activated by engaging the mechanical brakes by either using the right-hand brake lever or the foot brake. In the first mode, the effect of engaging the regen button and the mechanical brake together is not additive.

As will be appreciated based upon the foregoing specification, the above-described embodiments of the disclosure may be implemented using computer programming or engineering techniques including computer software, firmware, hardware or any combination or subset thereof. Any such resulting program, having computer-readable code, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are examples only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are examples only, and are thus not limiting as to the types of memory usable for storage of a computer program.

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

1. An electric motor assembly comprising:
an electric motor frame including a main segment and an arm segment, wherein the arm segment extends rearward from the main segment:
an electric motor housed within the main segment of the electric motor frame: and
a belt drive assembly housed within the arm segment, the belt drive assembly being connectable to a rear wheel assembly.

2. The electric motor assembly of claim 1, wherein the arm segment to form a swing arm when the electric motor assembly is operatively assembled on an electric motor bike.

3. The electric motor assembly of claim 1, wherein the main segment includes a cylindrical body to house the electric motor, and wherein the electric motor includes a shaft that extends from an end segment of the cylindrical body.

4. The electric motor assembly of claim 3, wherein the shaft engages a belt drive assembly that is housed within the arm segment.

5. The electric motor assembly of claim 4, wherein the belt drive assembly includes a front flywheel and a rear flywheel, the front fly wheel connecting to the shaft of the motor within a front portion of the arm segment, and wherein the front and rear fly wheels being connected by a belt or chain.

6. The electric motor assembly of claim 1, wherein the electric motor frame is formed from sheet metal panels that are fixtured together using rivets.

7. A method for forming a frame component for a motorbike, the method comprising:
determining a set of attributes for multiple plates:
determining one or more overlap regions as between the multiple plates;
shaping sheet metal into each of the multiple plates, including cutting, bending, folding and forming rivet holes in the sheet metal;
wherein each of the multiple plates includes one or more overlap strips, and wherein the rivet holes are formed in each of the one or more overlap strips:
applying adhesive to the overlap strips:
adhering the shaped plates to one another in accordance with a plate pattern:
inserting rivets in the rivet holes of the one or more overlaps strips: and
curing plates to form a frame assembly for the motorbike.

8. An electrical motorbike comprising:
a battery assembly including a battery module:
a lighting assembly, the lighting assembly including at least a first light component and a second light component, the first light component including a battery:
wherein the lighting assembly includes a frame; and
wherein the first light component is structured to attach and detach from the frame, wherein when the first light component is attached, the first light component is charged and/or powered by the battery module, and wherein when the first light component is detached, the first light component operates as a portable light.

9. The electrical motorbike of claim 8, wherein the first light component is positioned above the second light component.

10. The electrical motorbike of claim 9, wherein the first light component is operable when attached as an auxiliary light.

11. The electrical motorbike of claim 10, wherein the first light component is operable when detached as a portable charger or power source for electronic devices.

12. A motorbike comprising:
a frame assembly:
a seat structure assembly, the seat structure assembly including a seat and one or more pneumatic cylinders that are supported by the frame assembly:
wherein the pneumatic cylinders couple to the seat to raise or lower at least a portion of the seat.

13. The motorbike of claim 12, further comprising a control component that is operable by a user to actuate the pneumatic cylinders to or from a raised or lowered position.

14. The motorbike of claim 13, wherein the control component utilizes one or more mechanical levers.

15. The motorbike of claim 13, wherein the control component utilizes an electrical actuator.

16. The motorbike of claim 13, wherein the pneumatic cylinders include gas cylinders.

17. The motorbike of claim 13, further comprising a modularized front assembly.

18. The electric motorcycle of claim 17, wherein the modularized front assembly includes a modular headtube component.

19. The electric motorcycle of claim 18, wherein the modular headtube component is secured to a frame component of the electric motorcycle, using a flat plate installed between a collar and the frame component.

20. The electric motorcycle of claim 19, wherein the modular headtube component can be non-destructively disengaged from the frame.
